(19) United States
(12) Patent Application Publication
(10) Pub. No.: US 2020/0067829 A1
(43) Pub. Date: Feb. 27, 2020

(54) METHODS AND DEVICES FOR INTELLIGENT SELECTION OF CHANNEL INTERFACES

(71) Applicant: CA, Inc., New York, NY (US)

(72) Inventor: Thomas Brown, Apex, NC (US)

(21) Appl. No.: 16/113,643

(22) Filed: Aug. 27, 2018

(51) Int. Cl. H04L 12/721; H04L 12/46

(52) U.S. Cl. CPC H04L 45/34; H04L 12/4641

(57) ABSTRACT

A method includes performing, by a processor, determining a source address or a target address of an inbound packet received by a single application from a first tenant of a multitenant network including a plurality of tenants, determining a network interface on which the inbound packet from the first tenant is received, marking the inbound packet with a mark based on the network interface, preparing an outbound packet in response to the inbound packet, the outbound packet including the source address or the target address, marking the outbound packet with the mark, and routing the outbound packet to the network interface for forwarding to the first tenant based on the mark. Related devices, computer program products, and computer systems are described.

### BACKGROUND

The ubiquitous present of Internet connected devices worldwide has led to vast networks with applications and connected devices arranged in various networks with communications therebetween. Increasing aspects of personal, social and professional lives are governed by applications. An application may be connected to the user's computer through any type of network, including a local area network (LAN) or a wide area network (WAN), or the connection may be made to an external computer (for example, through the Internet using an Internet Service Provider) or in a cloud computer environment or offered as a service such as a Software as a Service (SaaS).

### SUMMARY

Various embodiments of the present invention are directed to a method including performing operations as follows by a processor. The operations include determining a source address or a target address of an inbound packet received by a single application from a first tenant of a multitenant network including a plurality of tenants, determining a network interface on which the inbound packet from the first tenant is received, marking the inbound packet with a mark based on the network interface, preparing an outbound packet in response to the inbound packet, the outbound packet including the source address or the target address, marking the outbound packet with the mark, and routing the outbound packet to the network interface for forwarding to the first tenant based on the mark.

In some embodiments, the source address may include a first network address of the first tenant that overlaps with a second network address of a second tenant of the plurality of tenants that are communicating with the single application. The first network address may include the second network address. The inbound packet may include a first inbound packet and the network interface may include a first network interface, and the mark may include a first mark.

In some embodiments, the method may include determining a second network interface on which a second inbound packet from the second tenant is received, and marking the second inbound packet with a second mark based on the second network interface. The first network interface may be different from the second network interface, and the first mark may be different from the second mark.

In some embodiments, the outbound packet may include a first outbound packet, and a first source address of the first inbound packet from the first tenant may include the source address, and a second source address of the second inbound packet from the second tenant may include the source address. The method may further include preparing a second outbound packet in response to the second inbound packet, the second outbound packet including the source address, marking the second outbound packet with the second mark, and routing the second outbound packet to the second network interface for forwarding to the second tenant based on the second mark.

In some embodiments, the method may include determining a first routing policy for routing the first outbound packet based on a first combination of the first source address and the first mark, and determining a second routing policy for routing the second outbound packet based on a second combination of the second source address and the second mark. The routing the first outbound packet to the first network interface may be based on the first routing policy, and the routing the second outbound packet to the second network interface may be based on the second routing policy.

The method may include determining a Virtual Local Area Network (VLAN) identifier associated with the inbound packet, where the routing the outbound packet is further based on the VLAN identifier. The inbound packet may include a first inbound packet, and the mark may include a first mark. The method may include determining that a second inbound packet from the second tenant is received on the network interface on which the first inbound packet is received, and determining a first Virtual Local Area Network (VLAN) identifier associated with the first inbound packet and a second VLAN identifier associated with the second inbound packet. The marking the first inbound packet may include marking the first inbound packet with the first mark based on the network interface and the first VLAN identifier.

The method may include marking the second inbound packet with a second mark based on the network interface and the second VLAN identifier, where the first mark is different from the second mark. The outbound packet may include a first outbound packet, and a first source address of the first inbound packet from the first tenant may include the source address, and a second source address of the second inbound packet from the second tenant may include the source address. The method may include preparing a second outbound packet in response to the second inbound packet, the second outbound packet including the source address, marking the second outbound packet with the second mark, associating the second outbound packet with the second VLAN identifier based on the second mark, and routing the second outbound packet to the network interface for forwarding to the second tenant based on the second mark and the second VLAN identifier associated with second outbound packet.

In some embodiments, the method may include determining a first routing policy for routing the first outbound packet based on a first combination of the first source address, the first VLAN identifier, and the first mark, and determining a second routing policy for routing the second outbound packet based on a second combination of the second source address, the second VLAN identifier, and the second mark. The routing the first outbound packet to the first network interface may be based on the first routing policy, and routing the second outbound packet to the second network interface may be based on the second routing policy. The mark may not alter data in the inbound packet that was received. The mark may be maintained in an upstream and a downstream direction by a local network stack. In some embodiments, the network interface may include at least one of a physical interface, a virtual interface, or a tunnel endpoint. The operations may be performed by a single application. The operations may be performed by a customer aggregation switch associated with a virtual network appliance without modifying the single application running on a service provider host.

Various embodiments of the present inventive concept include a computer program product, that includes a tangible non-transitory computer readable storage medium storing computer readable program code which when executed by a processor of an electronic device causes the processor to perform operations as follows by a processor. The computer program product may include computer readable code to determine a source address or a target address of an inbound packet received by a single application from a first tenant of a multitenant network including a plurality of tenants, computer readable code to determine a network interface on which the inbound packet from the first tenant is received, computer readable code to mark the inbound packet with a mark based on the network interface, computer readable code to prepare an outbound packet in response to the inbound packet, the outbound packet including the source address or the target address, computer readable code to mark the outbound packet with the mark, and computer readable code to route the outbound packet to the network interface for forwarding to the first tenant based on the mark.

In some embodiments, the inbound packet may include a first inbound packet, the network interface may include a first network interface, and the mark may include a first mark. The computer readable program code may further include computer readable code to determine a second network interface on which a second inbound packet from the second tenant is received, and computer readable code to mark the second inbound packet with a second mark based on the second network interface. The first network interface may be different from the second network interface, and the first mark may be different from the second mark. The computer readable program code may further include computer readable code to determine that a second inbound packet from a second tenant is received on the network interface on which the first inbound packet is received, computer readable code to determine a first Virtual Local Area Network (VLAN) identifier associated with the first inbound packet and a second VLAN identifier associated with the second inbound packet, computer readable code to mark the first inbound packet with the first mark based on the network interface and the first VLAN identifier, and computer readable code to mark the second inbound packet with a second mark based on the network interface and the second VLAN identifier.

Various embodiments of the present inventive concept include an electronic device, including a processor, and a memory coupled to the processor and including computer readable program code embodied in the memory that when executed by the processor causes the processor to perform operations as follows by a processor. The operations include determining a source address or a target address of an inbound packet received by a single application from a first tenant of a multitenant network including a plurality of tenants, determining a network interface on which the inbound packet from the first tenant is received, marking the inbound packet with a mark based on the network interface, preparing an outbound packet in response to the inbound packet, the outbound packet including the source address or the target address, marking the outbound packet with the mark, and routing the outbound packet to the network interface for forwarding to the first tenant based on the mark.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Features of embodiments will be more readily understood from the following detailed description of specific embodiments thereof when read in conjunction with the accompanying drawings, in which:

FIG. 1 illustrates a carrier ethernet network for providing services over a network, according to some embodiments of the present inventive concept.

FIGS. 2 to 7 illustrate various topologies for routing of traffic, according to some embodiments of the present inventive concept.

FIGS. 8, 9A, 9B, 9C, 9D, 10A, 10B, and 10C provide example configurations, according to some embodiments of the present inventive concept.

FIGS. 11 to 19 are flowcharts that illustrate operations for routing traffic, according to some embodiments of the present inventive concept.

FIG. 20 is a block diagram of an electronic device configured according to some embodiments of the present inventive concept.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

Ubiquitous use of various software applications by users of computing devices has provided the need for extensive networking globally. Applications may be connected to the user's computer or other device through any type of network, including a local area network (LAN) or a wide area network (WAN), or the connection may be made to an external computer or in a cloud computer environment or offered as a service such as a Software as a Service (SaaS). SaaS may be running on a service provider host. Various networks may provide access for a service provider host. The networks may include various tenants, customers, or customer endpoints that access a software application through the service provider. However, overlapping network addresses may result when an IP address is assigned to a device on a first network that is already legally owned and/or assigned to a different device on the Internet and/or outside of the first network.

The application stack of legacy systems may have difficulty in communicating with multiple tenants that have overlapping IP addresses. Various embodiments described herein may arise from the recognition for a need to enable large communication service providers to communicate with multiple client endpoints, i.e. tenants, that share overlapping IP address space. The present inventive concepts may use a mark to make routing decisions to distinguish different tenants. Legacy systems may use a mark to prioritize types of traffic, such as prioritizing FTP traffic over web traffic. According to various embodiments described herein, a mark may be applied by the kernel, operating system, or other portions of the application to inbound packets to aide in routing decisions of outbound packets for situations where IP addresses may be overlapped. As used herein, an overlapping IP address may be an IP address that is shared by two devices. The present inventive concepts may be applied to masked portions of an IP address or an IP subnet mask.

According to some embodiments described herein, devices may be managed by bidirectionally routing network traffic by origin to allow a single application to communicate with multiple tenants that use overlapping address ranges. The present inventive concepts provide efficient techniques of communicating with multiple network endpoints that utilize overlapping IP address space without having to deploy multiple logically-isolated network components. These techniques may allow a high degree of scalability with reduced resources, enabling more effective communication as network technologies grow in complexity, scale, and with uncontrollable factors such as private IP address assignments.

A large Software as a Service (SaaS) provider or Communication Service Provider (CSP) may communicate with multiple customer tenant networks that utilize overlapping address space without the need for dedicated application platforms for each customer. This could result in substantial reduction of infrastructure, and associated cost and management overhead.

According to various embodiments described herein, inverse source routing solutions could benefit large service providers that make use of Carrier Ethernet to connect to their customer tenant private networks. Rather than requiring customers to utilize public Internet connections to guarantee uniqueness of IP address space, private connectivity to customer networks by Software as a Service (SaaS) providers may not be possible without worrying about overlapping IP address space conflicting within a shared application stack. By employing these inverse source routing techniques, it may be possible for network equipment manufacturers to scale their services more economically, and to provide services to customers that utilize overlapping IP address space without logically or physically-isolated appliances. Applied to Software-defined networking (SDN), inverse routing techniques described herein may be a powerful tool for effectively running software for multiple, distributed tenants.

According to various embodiments described herein, a multi-tenant Layer-2 WAN network monitoring solution for large Communications Service Providers is described. Layer-2 WAN technology, or Carrier Ethernet, allows customers to interconnect geographically-dispersed networks as if they were local, allowing the use of common IP address space across multiple locations rather than routing traffic from one network to another. VPWS (Virtual Private Wire Service) is a simple form for enabling Ethernet services over MPLS. VPWS may also be referred to as ETHoMPLS (Ethernet over MPLS), or VLL (Virtual Leased Line).

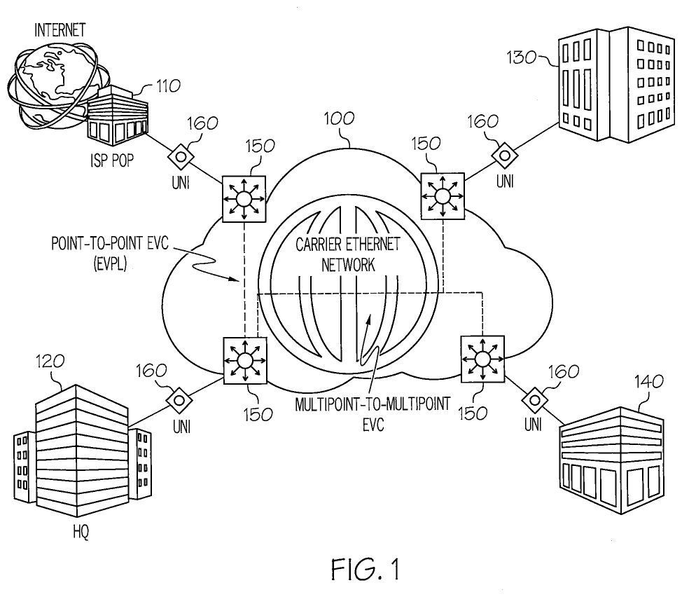

FIG. 1 illustrates an EVP-LAN Carrier Ethernet network. An example of Carrier Ethernet service is Ethernet Virtual Private LAN (EVP-LAN), where multipoint-to-multipoint customer traffic is logically separated using, for example, VLAN IDs numbered 2 through 4088, transmitted through a service-multiplexed User Network Interface (UNI). Referring now to FIG. 1, customers of ISP POP 110, or local networks 120, 130, and 140 may have the same or similar IP addresses. For example, IP address space contention may occur between tenants connected to an ISP POP 110 and tenants connected to local networks 120, 130, and/or 140. ISP POP 110, and local networks 120, 130, and 140 may be connected to a carrier ethernet network 100 through User Network Interfaces (UNIs) and customer aggregation switches 150. As Carrier Ethernet is typically used to join private networks, individual parties may choose to use not only registered IP address space reserved for their exclusive use, but also unregistered IP address space (i.e. as specified in RFC 1918, “Address Allocation for Private Internets”). Registered IP space may be used over shared public networks such as the Internet, in an attempt to guarantee uniqueness between endpoints. Private IP space may be used internally, or coordinated between two parties. Being unregulated, multiple unrelated parties may choose to use the same private IP addresses, presenting challenges with traditional operating system routing stacks.

Even with multiple logical network interfaces or VLAN-tagged network trunks, traditional routing stacks on operating systems, such as Linux or Windows, are unable to differentiate traffic received from multiple sources (i.e. VLANs or interfaces) with overlapping addresses. Once a packet is received by the network kernel, it may be processed in a common pool where source and destination IP address are considered for routing decisions. For example, two tenant endpoints, such as one tenant in local network 120 and one tenant in local network 130, may use the same subnet or the same source IP address to send data to a host. There may not be a way to differentiate between the network data received from those two tenants by devices inside the carrier ethernet network 100.

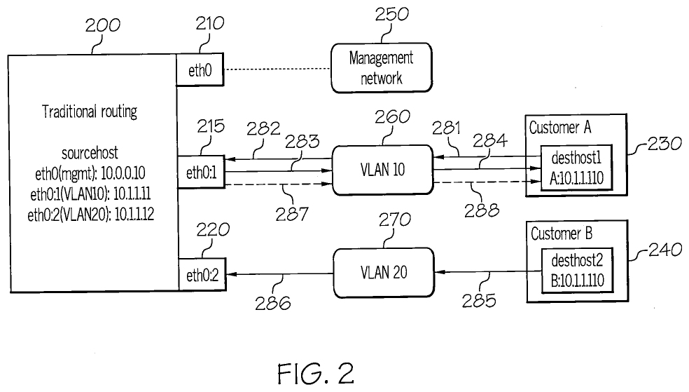

FIG. 2 illustrates a case where multiple tenants with overlapping IP space are connected to a single application stack. Referring now to FIG. 2, customer 230 and customer 240 may be in communication with a customer service provider host 200 that may be in the carrier ethernet network 100 of FIG. 1. The customer service provider host 200 may be configured as an application host and/or a SaaS host that runs a software application. Customer service provider host 200 may be configured to provide traditional routing of packets to customer 230 and/or customer 240. Customer service provider host 200 may include various interfaces, such as physical interface 210 or logical interfaces 215, 220. Physical interface 210 may be, for example, an 802.11 trunk whereas logical interfaces 215, 220 may be logical interfaces configured to use different VLANs.

Example routing success and failure scenarios with respect to FIG. 2 will now be discussed in detail. Customer 230 and Customer 240, which are tenants in different local networks of carrier ethernet network 100, may both use IP address 10.1.1.110. Customer 230 may initiate a connection, 281, from desthost1 of customer 230, routed to a sourcehost associated with customer service provider host 200 on VLAN10 (reference 260). The IP addresses used for connection 281 may be denoted as (A:10.1.1.110->10.1.1.11). A packet may be received, 282, by the sourcehost of customer service provider host 200 using interface 215 (eth0:1). A return packet may be sent, 283, by the sourcehost of customer service provider host 200 via interface 215 (eth0:1) based on desthost1 network (10.1.1.0/24), which matches interface IP (eth0:1) first. A return packet may be received, 284 by the desthost1 of customer 230 in a successful scenario.

In a failure scenario, a connection may be initiated from desthost2 of customer 240, and routed, 285, to the sourcehost of customer service provider host 200 on VLAN 20, denoted as (B:10.1.1.110->10.1.1.12). The packet may be received, 286, by the sourcehost of customer service provider host 200 by interface 220 (eth0:2). However, the return packet may be sent, 287 by the sourcehost of customer service provider host 200 via interface 215 (eth0:1) based on desthost2 network (10.1.1.0/24), which matches interface IP (eth0:1) first. The return packet will then be sent, 288, incorrectly to customer 230 instead of customer 240, resulting in a failure scenario. Once the packet is received, 286, by the network kernel of the sourcehost of customer service provider host 200, the network kernal does not know the interface on which the packet was received when sending the returned packet. Based on this example scenario, one may understand that there is a challenge in providing multi-tenant services to Carrier Ethernet-connected customers.

As described earlier, given that every customer utilizing Carrier Ethernet could potentially utilize thousands of VLANs per UNI, each of which might contain overlapping IP address space, having to deploy an individual set of resources to service each VLAN could easily scale out of control. The ability to allow a single set of resources to service multiple VLANs with overlapping IP address space may sharply reduce resource requirements.

In the example of a large, multi-tenant network monitoring solution designed to communicate with multiple customer internal networks, each customer internal network may be using the same IP address space. Even with multiple logical network interfaces or VLAN-tagged network trunks, most operating system network stacks may be incapable of natively processing and distinguishing between packets with overlapping IP address space, such that a given network stack may only service a single customer network. When dealing with hundreds of customer networks, such a monitoring solution may need to be scaled proportionally, thereby increasing resource utilization and operating cost. Some network appliances, such as firewalls, may be designed to virtualize multiple instances of the service, each with their own independent network stack. This virtualization is typically performed on a relatively small scale (e.g. up to 25 virtual instances) and at large cost for licensing and/or hardware capability. Handling hundreds of customers may require hundreds of such virtual firewall instances, the scale and cost of which may quickly become a limiting design factor.

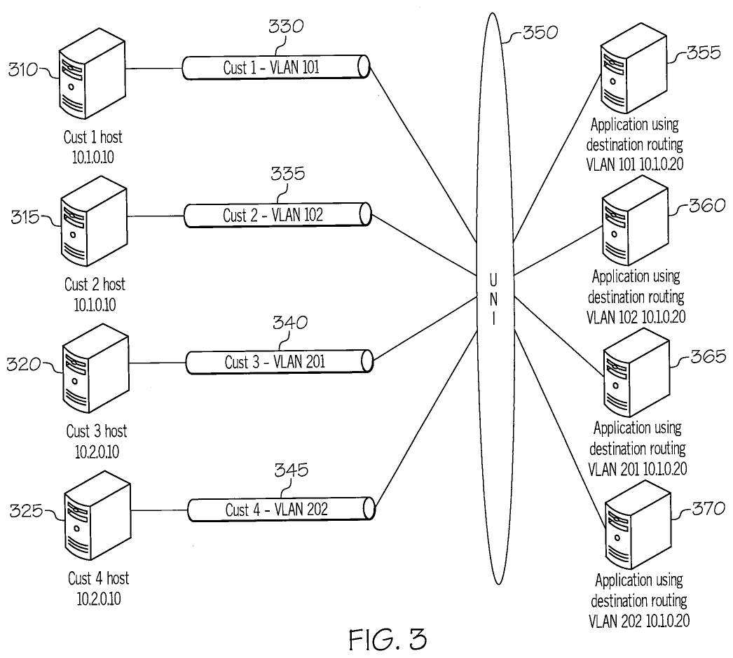

A network monitoring application may need to communicate with multiple customer endpoints over a Carrier Ethernet connection, all of which use the same network address. Using traditional routing techniques, one would have to deploy a separate network monitoring application instance, each on a separate operating system instance, to differentiate between the endpoints. FIG. 3 illustrates a legacy multi-tenant use case. Referring now to FIG. 3, tenants, customer endpoints, or customer hosts 310, 315, 320, 325 may use the same IP address, 10.2.0.10 but unique VLANs 330, 335, 340, and 345, respectively to send traffic through UNI 350 to service provider host 355, 360, 365, 370, respectively. Using dedicated resources for large network monitoring applications may require thousands of servers, consuming a large number of computing resources and leading to high cost of ownership for administration, licensing, etc. Thousands of customers may translate to thousands of individual application and/or host instances.

In order to address the issues with large networks, various embodiments described herein apply inverse source routing techniques such that network packets may be routed using not only destination and/or source addresses, but also by tracking the network interface over which they are transported, thus allowing bidirectional communication between a single application and multiple client endpoints whose network addresses overlap with each other.

Upon receipt of a packet from a particular interface (e.g. a virtual interface associated with a specific customer VLAN), the packet may be marked in such a way as to allow applications aware of this marking to directly distinguish between different customer endpoints that use identical IP addresses. Traffic may be directed to a specific network interface and/or VLAN based on a combination of source or target address plus the interface and/or VLAN identifier, which may allow multiple network conversations using the same network address to be treated as unique and routed accordingly, using a single network stack. The techniques described herein are not limited to Internet Protocol (IP) packet types, but are described in the context of IP packets as non-limiting examples. Any network packet, regardless of protocol, may be tagged based on network interface (physical, virtual, tunnel endpoint, etc.) and subsequently routed based on that tag, as described herein by various embodiments.

Several protocols attempt to separate user traffic during transport. VLAN-tagged network trunks, such as specified, for example, by IEEE 802.1Q, modify network packets to add a VLAN tag to allow switching apparatus to isolate the traffic of one VLAN from another. In doing so, traffic from multiple networks, perhaps with overlapping IP addresses, are kept separate from each other in transit.

Multiprotocol Label Switching (MPLS) directs data from one network node to the next based on short path labels rather than long network addresses, avoiding complex lookups in a routing table. The labels identify virtual links (i e paths) between distant nodes rather than endpoints. Network packets may be encapsulated within an MPLS frame, and tunnels are built between points of demarcation that connect to various endpoints. Label-Switched Paths (LSP) may be set up to allow network routing decisions to be made by Label Switch Routers (LSR) or Label Edge Routers (LER) based on these labels. Like 802.1Q trunks, these MPLS tunnels may be capable of carrying network traffic with overlapping IP address space.

However, 802.1Q VLAN trunks, MPLS networks, or other encapsulation or tunneling techniques do not solve the problem of handling traffic with overlapping IP address space at the endpoint itself. Once network traffic leaves the network transit mechanism and ultimately lands on a traditional operating system kernel network stack, overlapping IP addresses may again become ambiguous to applications running on that platform as information about their initial origin in transit may be have been stripped off.

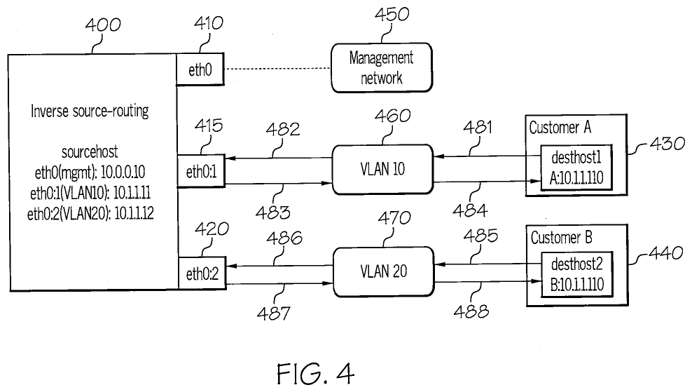

FIG. 4 illustrates a network traffic flow utilizing inverse source routing based on marking packets upon receipt from tenants with overlapping address space. Referring to FIG. 4, customer 430 may initiate a connection, 481, from desthost1 of customer 430, which is routed to the sourcehost of customer service provider host 400 on VLAN 10 (A:10.1.1.110->10.1.1.11). The packet may be received, 482, by the sourcehost of customer service provider host 400 at interface 415 (eth0:1). An inverse source route mark “11”, also referred to as a “mark”, may be added upon receipt of the packet by the sourcehost of customer service provider host 400. A return packet may be sent, 483, by the sourcehost of customer service provider host 400 via interface 415 (eth0:1) based on inverse source route mark “11”. The return packet may be received, 484, by desthost1 of customer 430 successfully.

In another scenario, customer 440 may initiate a connection, 485, from desthost2 of customer 430. The packet sent on the connection may be routed to sourcehost of customer service provider host 400 on VLAN 20 (B:10.1.1.110->10.1.1.12). The packet is received, 486, by the sourcehost of customer service provider host 400 at interface 420 (eth0:2). Upon receipt at interface 420, inverse source route mark “12” may be added. A return packet may be sent, 487, by the sourcehost of customer service provider host 400 via interface 420 eth0:2 based on route mark “12”. Since the return packet is routed based on the mark, the return packet is received, 488, by desthost2 of customer 440 successfully.

In the examples discussed with respect to FIG. 4, each VLAN is associated with a different virtual interface, but the techniques described herein may also be used with different physical interfaces. The inverse source route marks may not be part of the packet, but are used as part of an external tracking mechanism such as a connection tracking module in the kernel. In other words, the contents of the data packets may not be altered. The mark may be known internally to the sourcehost of the customer service provider host 400, but not available externally. Routing tables used by the source host of customer service provider host 400 may have additional fields to include the mark. Different policies may be configured such that the kernel uses the mark to make routing decisions.

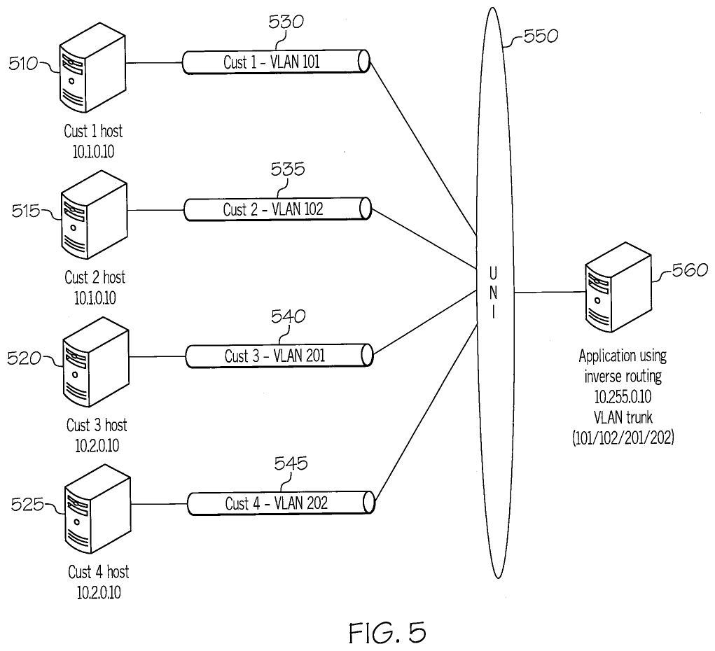

FIG. 5 illustrates a large, multi-tenant Carrier Ethernet network monitoring solution connected via a User Network Interface (UNI) that has been simplified when compared to the legacy network of FIG. 3, according to various embodiments described herein. Referring now to FIG. 5, tenants, customer endpoints, or customer hosts 510, 515, 520, 525 may use the same IP address, 10.1.0.10 and unique VLANs 530, 535, 540, and 545, respectively to send traffic through UNI 550 to the same service provider host 560. The application running on service provider host 560 may be using inverse routing with marking, according to various embodiments described herein, such that a single service provider host 560 may be deployed to handle the traffic from various customer hosts with overlapping IP addresses.

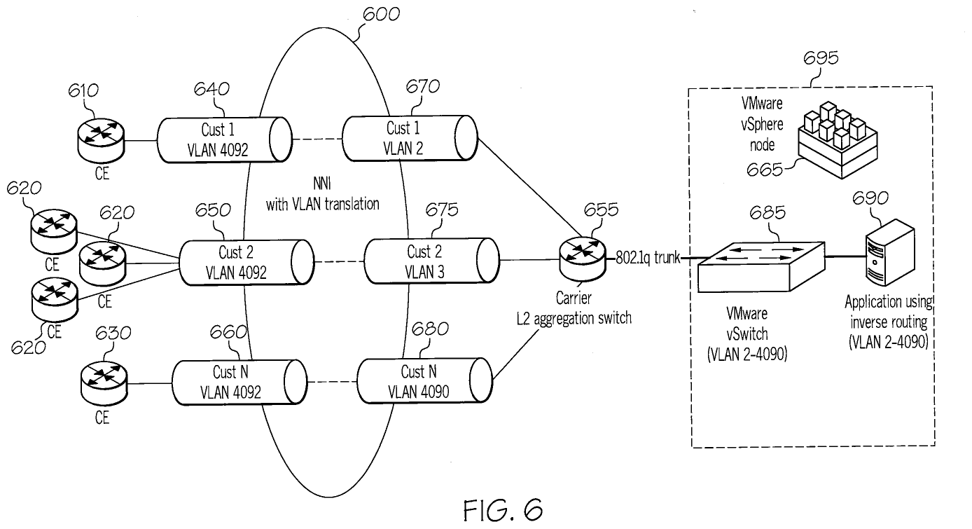

Some service providers may also offer Carrier Ethernet connectivity via a Network to Network Interface (NNI) with VLAN translation, to allow customers the freedom to choose which VLAN ID to use on their side of the link. FIG. 6 illustrates a multitenant network with NNI 660 using VLAN translation. Various customer endpoints 610, 620, 630 may use customer VLANs 640, 650, and 660, respectively. However, the customer VLANs may not be unique and may be using VLAN 4092. The NNI 600 may provide VLAN translation such that these VLANs are mapped to unique customer VLANs 670, 675, and 680. The traffic may be provided to a L2 carrier aggregation switch 655 which may be use an 802.1q trunk to communicate with a single virtual switch and/or IP virtual host 695. The IP virtual host 695 may include, for example, a VMware vSphere node 665, VMware vSwitch 685, and/or an application host 690 that runs an application using inverse routing with marking, according to various embodiments described herein.

According to some embodiments, network address translation (NAT) may be introduced to allow traditional applications, unaware of packet marking, to connect to these same customer endpoints using unique translated IP addresses. A limitation with this approach may be that the translated IP range would be unavailable for customer use, though this may be addressed by the use of registered IP space that should not be utilized by tenant networks.

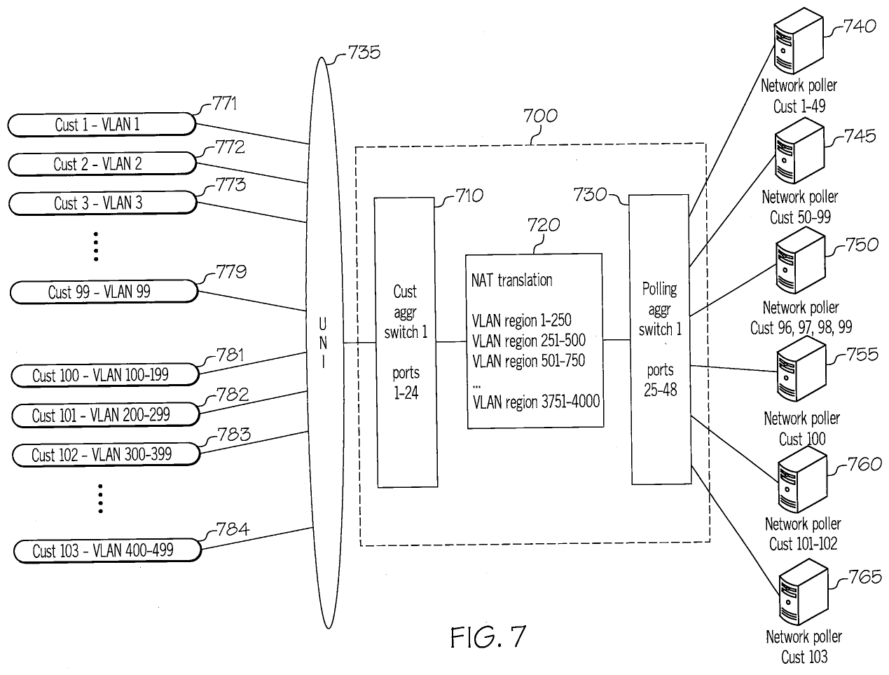

FIG. 7 illustrates a network that utilizes a combination of inverse source routing with NAT. Referring to FIG. 7, customer vlans 771, 772, 773, 779, 781, 782, 783, and/or 784 may be used by various customer endpoints to communicate through UNI 735. Traffic may be routed to a virtual host or virtual network appliance 700 such as a network proxy, firewall, or a virtual network application. The virtual network appliance 700 may include a customer aggregation switch 710, a virtual NAT appliance 720 that provides a NAT translation function, and/or a polling aggregation switch 730 for distribution of traffic to backend hosts. Service provider hosts 740, 745, 750, 755, 760, and/or 765, also referred to as backend hosts, may not need to be modified in this example to use marking. Instead, marking may occur in the customer aggregation switch 710. In this case, the marking would not reach the backend hosts and external packet tagging is used.

As previously described, it may be possible to assign a local internal identifier, or “mark”, to a packet that does not alter the packet frame data. This mark, known only to the local network stack, may be used as the basis for tracking the logical origin of a packet. The network routing module may then direct these packets to a given physical interface based on their mark rather than simply by source or target IP address. For example, Linux 2.4.x and later kernels provide a method by which packets entering or leaving the network stack may be externally marked by the ‘netfilter’ “CONNMARK” target extension module, using an ‘iptables’ firewall “MARK” rule. ‘Netfilter’ may be a set of hooks inside the Linux kernel that allows kernel modules to register callback functions with the network stack. A registered callback function may then be called back for every packet that traverses the respective hook within the network stack.

Configurations according to various embodiments described herein will now be discussed with respect to FIG. 8 to FIG. 10C. FIG. 8 illustrates configuration of the interfaces and routing tables. Referring to FIG. 8, marking inbound network packets may be based on the inbound interface, at 810. The network routing policy may be configured based on marked packets, at 820. Therefore, routing decisions are made based on the marks. Packets are tagged by their logical origin (i.e. network interface or VLAN), such that is may be possible to differentiate between and communicate distinctly with multiple logically-connected tenants that utilize overlapping IP address space.

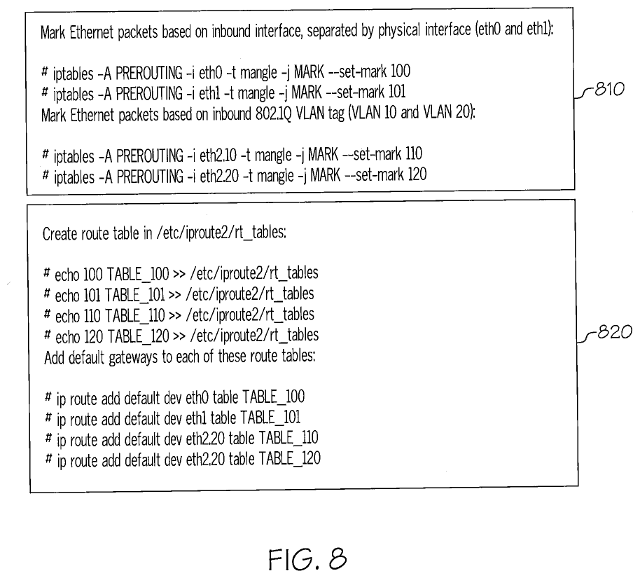

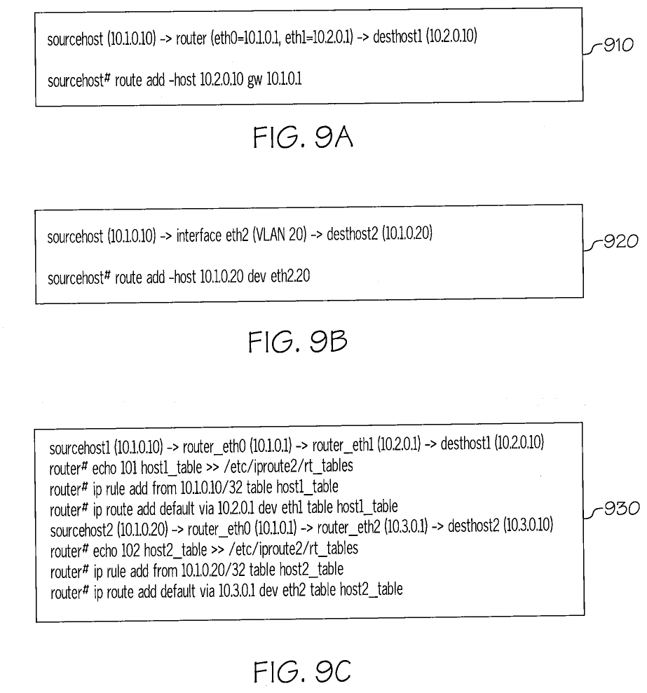

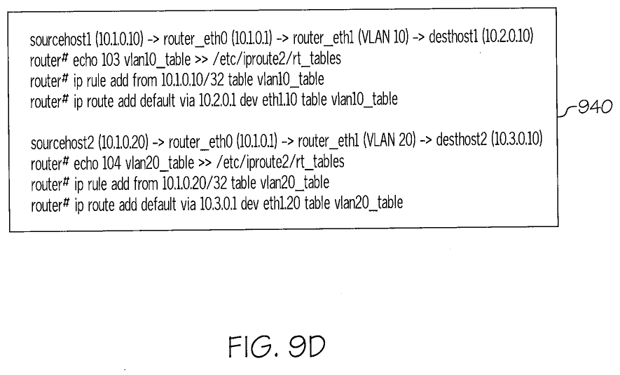

FIGS. 9A, 9B, 9C, and 9D illustrate several networking routing mechanisms, which may be applied in legacy systems or in systems implementing the present inventive concepts. Referring to FIG. 9A, destination-based routing directs network traffic out to a specific network interface and/or VLAN based on the destination address. Routers in the network determine the path based on the best next hop to the destination. For example, traffic may pass for ‘desthost1’ through a router that has interfaces on the networks of both ‘sourcehost’ and ‘desthost1’, at 910. Referring to FIG. 9B, traffic for ‘desthost2’ may pass across a logical VLAN interface connected to the network of ‘desthost2’, at 920. Referring to FIG. 9C, source-based routing may allow the sender of a packet to partially or completely specify the route the packet takes through the network, such as specifying network interface and/or VLAN based on the source address. A Linux-based router may be configures such traffic passes over a particular interface (eth1 or eth2) based on the source address of the received packet, at 930. Referring to FIG. 9D, a similar situation at FIG. 9C is illustrated, but with traffic passing over two different logical VLANs (VLAN 10 or VLAN 20) on an 802.1Q VLAN-trunked interface (eth1) based on the source address of the received packet, at 940 . . . 9D

VLAN tagging may be applied to various embodiments described herein. IEEE 802.1Q7, often referred to as Dot1q, is the networking standard that supports virtual LANs (VLANs) on an IEEE 802.3 Ethernet network. This standard defines a system of VLAN tagging for Ethernet frames and the accompanying procedures to be used by bridges and switches in handling such frames.

Portions of the network which are VLAN-aware (i.e. 802.1Q conformant) may include VLAN tags. When a frame enters the VLAN-aware portion of the network, a tag may be added to the frame data to represent the VLAN membership. Each frame must be distinguishable as being within exactly one VLAN. A frame in the VLAN-aware portion of the network that does not contain a VLAN tag is assumed to be flowing on the native VLAN.

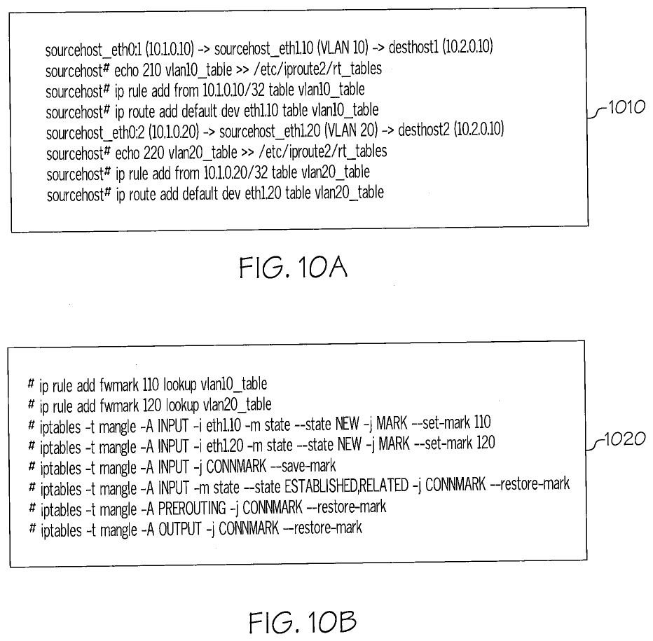

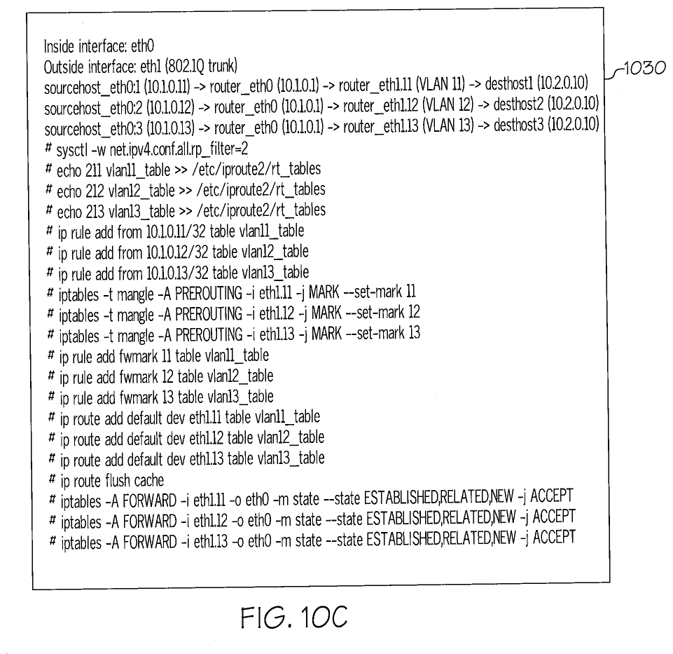

FIGS. 10A, 10B, and 10C provide example configurations of inverse source routing implementation, according to various embodiments described herein. Inverse source routing, like traditional source-based routing, may allow the sender of a packet to specify the route the packet takes through the network, such as specifying network interface and/or VLAN based on the source address, but also externally marks and tracks the packets based on the physical/logical interface of received packets to allow them to be treated uniquely by routing rules even if the endpoint uses conflicting address space. A host running a single application instance may then present multiple virtual interfaces to the network, each with a unique local IP address, to communicate with endpoints that use overlapping address space. For example, a Linux-based router passes traffic over a particular VLAN interface (VLAN 10 or VLAN 20) based on the source address of the received packet, and marks received packets from these VLAN interfaces such that traffic from multiple endpoints using the same IP address are kept separate. The sourcehost may be set up with two logical interfaces on eth0, eth0:1 and eth0:2, each with a unique IP address. The source may have an 802.1Q trunked interface on ‘eth1’ connected to multiple VLANs.

Referring to FIG. 10A, traditional source routing may be set up to be able to initiate outbound communications to target a host on a given logical VLAN interface, at 1010. Referring to FIG. 10B inbound network packets may be marked based on the logical VLAN interface over which they are received, such that stateful responses will be transmitted out that same interface, at 1020. Incoming packets are given to the ‘connmark’ extension to do connection tracking of the marked connections and marking of associated outgoing packets. Referring to FIG. 10C, overlapping endpoints may be handled on a larger scale, with an intermediate device set up to perform this routing in bulk, at 1030.

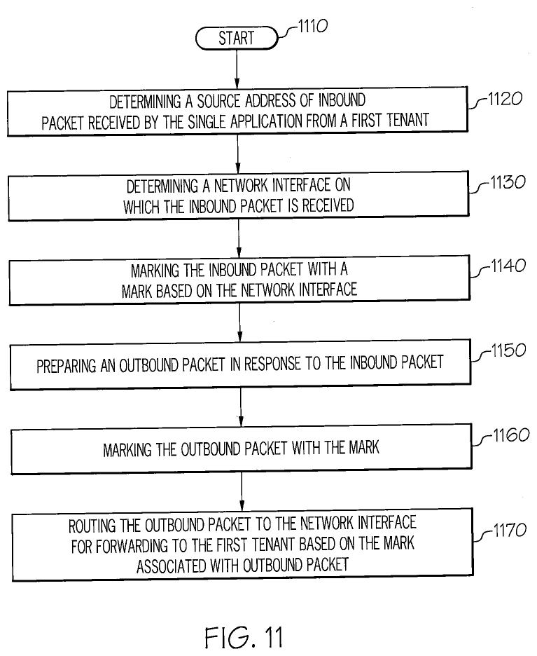

FIG. 11 is a flowchart that illustrates operations for distinguishing traffic to/from a single application in a multitenant network. Referring now to FIG. 11, the operations include determining a source address or a target address of an inbound packet received by a single application from a first tenant of a multitenant network including a plurality of tenants, at block 1120. A network interface on which the inbound packet from the first tenant is received may be determined, at block 1130. The inbound packet may be marked with a mark based on the network interface, at block 1140. An outbound packet may be prepared in response to the inbound packet, at block 1150. The outbound packet may include the source address and/or the target address. The outbound packet may be marked with the mark, at block 1160. The outbound packet may be routed to the network interface for forwarding to the first tenant based on the mark, at block 1170. In some embodiments, the source address may include a first network address of the first tenant that overlaps with a second network address of a second tenant of the plurality of tenants that are communicating with the single application. The first network address may include the second network address. The inbound packet may include a first inbound packet and the network interface may include a first network interface, and the mark may include a first mark.

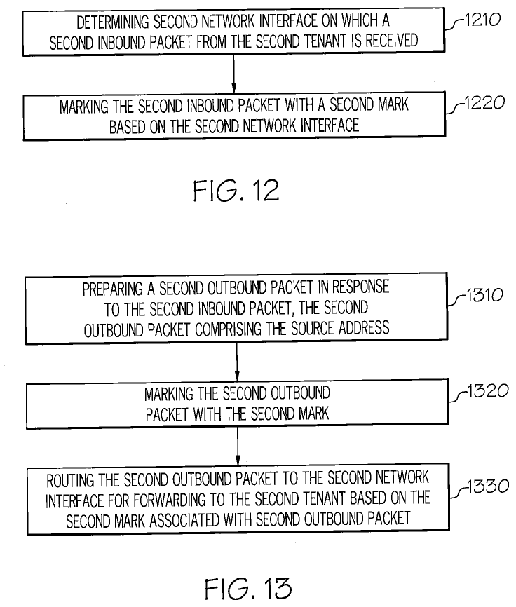

FIG. 12 is a flowchart that illustrates operations for distinguishing traffic to/from a single application in a multitenant network. Referring now to FIG. 12, a second network interface on which a second inbound packet from the second tenant is received may be determined, at block 1210. The second inbound packet may be marked with a second mark based on the second network interface, at block 1220. The first network interface may be different from the second network interface, and the first mark may be different from the second mark.

FIG. 13 is a flowchart that illustrates operations for distinguishing traffic to/from a single application in a multitenant network. In some embodiments, the outbound packet may include a first outbound packet, and a first source address of the first inbound packet from the first tenant may include the source address, and a second source address of the second inbound packet from the second tenant may include the source address. Referring now to FIG. 13, a second outbound packet may be prepared in response to the second inbound packet, at block 1310. The second outbound packet may include the source address. The second outbound packet may be marked with the second mark, at block 1320. The second outbound packet may be routed to the second network interface for forwarding to the second tenant based on the second mark, at block 1330.

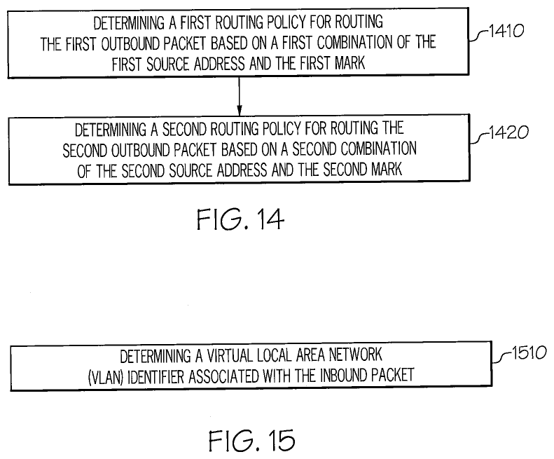

FIG. 14 is a flowchart that illustrates operations for distinguishing traffic to/from a single application in a multitenant network. Referring now to FIG. 14, a first routing policy for routing the first outbound packet based on a first combination of the first source address and the first mark may be determined, at block 1410. A second routing policy for routing the second outbound packet based on a second combination of the second source address and the second mark, may be determined, at block 1420. Routing the first outbound packet to the first network interface may be based on the first routing policy, and the routing the second outbound packet to the second network interface may be based on the second routing policy.

FIG. 15 is a flowchart that illustrates operations for distinguishing traffic to/from a single application in a multitenant network. Referring now to FIG. 15, a Virtual Local Area Network (VLAN) identifier associated with the inbound packet may be determined, at block 1510. Routing the outbound packet may be further based on the VLAN identifier.

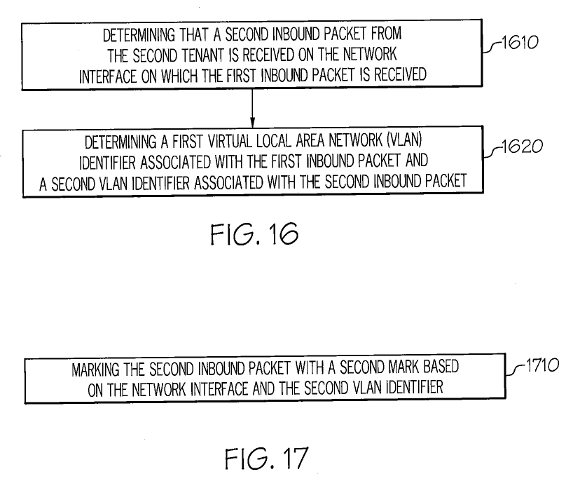

In some embodiments, the inbound packet may include a first inbound packet, and the mark may include a first mark. FIG. 16 is a flowchart that illustrates operations for distinguishing traffic to/from a single application in a multitenant network. Referring now to FIG. 16, it may be determined that a second inbound packet from the second tenant is received on the network interface on which the first inbound packet is received, at block 1610. A first Virtual Local Area Network (VLAN) identifier associated with the first inbound packet and a second VLAN identifier associated with the second inbound packet may be determined, at block 1620. The marking the first inbound packet may include marking the first inbound packet with the first mark based on the network interface and the first VLAN identifier.

FIG. 17 is a flowchart that illustrates operations for distinguishing traffic to/from a single application in a multitenant network. Referring now to FIG. 17, the second inbound packet may be marked with a second mark based on the network interface and the second VLAN identifier, at block 1710. The first mark may be different from the second mark.

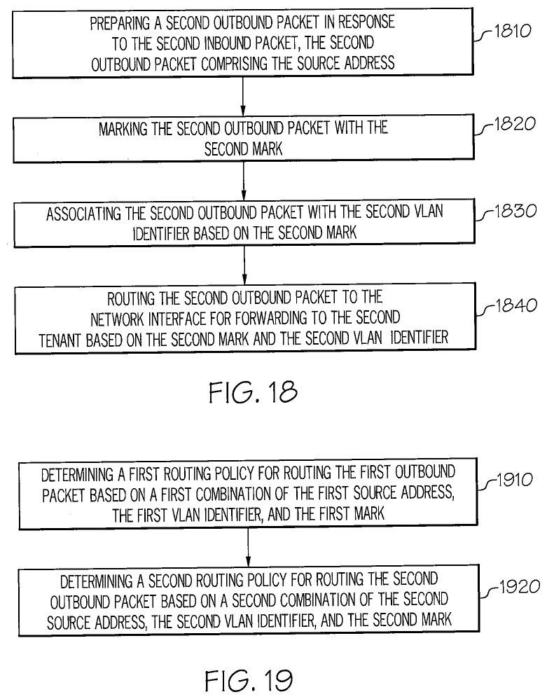

FIG. 18 is a flowchart that illustrates operations for distinguishing traffic to/from a single application in a multitenant network. The outbound packet may include a first outbound packet, and a first source address of the first inbound packet from the first tenant may include the source address, and a second source address of the second inbound packet from the second tenant may include the source address. Referring now to FIG. 18, a second outbound packet may be prepared in response to the second inbound packet, at block 1810. The second outbound packet may include the source address. The second outbound packet may be marked with the second mark, at block 1820. The second outbound packet may be associated with the second VLAN identifier based on the second mark, at block 1830. The second outbound packet may be routed to the network interface for forwarding to the second tenant based on the second mark and the second VLAN identifier associated with second outbound packet, at block 1840.

FIG. 19 is a flowchart that illustrates operations for distinguishing traffic to/from a single application in a multitenant network. Referring now to FIG. 19, a first routing policy for routing the first outbound packet may be determined based on a first combination of the first source address, the first VLAN identifier, and the first mark, at block 1910. A second routing policy for routing the second outbound packet may be determined based on a second combination of the second source address, the second VLAN identifier, and the second mark, at block 1920. Routing the first outbound packet to the first network interface may be based on the first routing policy. Routing the second outbound packet to the second network interface may be based on the second routing policy. The mark may not alter data in the inbound packet that was received. The mark may be maintained in an upstream and a downstream direction by a local network stack. In some embodiments, the network interface may include at least one of a physical interface, a virtual interface, or a tunnel endpoint. The operations may be performed by a single application. The operations may be performed by a customer aggregation switch associated with a virtual network appliance without modifying the single application running on a service provider host.

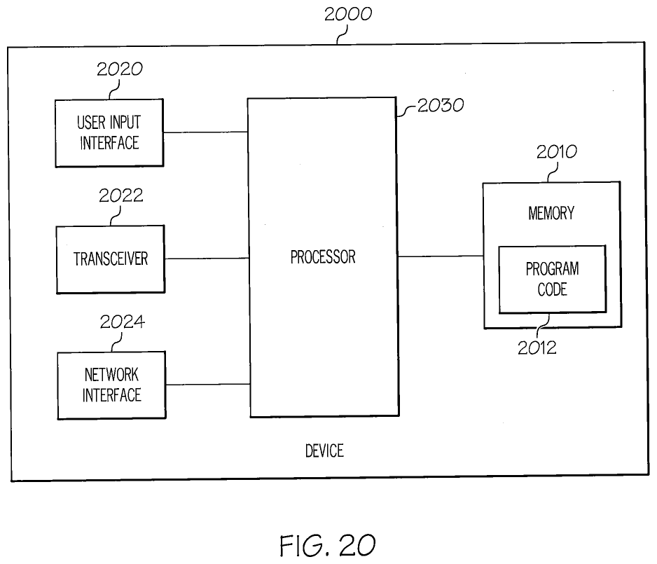

FIG. 20 is a block diagram of an electronic device 2000 configured according to some embodiments. The electronic device 2000 may include the electronic device 200 of FIG. 2, the electronic device 355, 360, 365, 370 of FIG. 3, the electronic device 400 of FIG. 4, and/or the customer aggregation switch 710 of FIG. 7. In some embodiments, the electronic device 2000 may be integrated with the service provider host or with the application host. Referring to FIG. 20, the electronic device 2000 includes a processor 2030, a memory 2010, a network interface 2024, and a transceiver 2022 which may include a radio access network transceiver and/or a wired network interface (e.g., Ethernet interface). The transceiver 2022 may be configured to communicate with a service provider network or data center operator.

The processor 2030 may include one or more data processing circuits, such as a general purpose and/or special purpose processor (e.g., microprocessor and/or digital signal processor) that may be collocated or distributed across one or more networks. The processor 2030 is configured to execute computer program code 2012 in the memory 2010, described as a non-transitory computer readable medium, to perform at least some of the operations described herein as being performed by an electronic device. The computer program code 2012 when executed by the processor 2030 causes the processor 2030 to perform operations in accordance with one or more embodiments disclosed herein for the electronic device 2000. The electronic device 2000 may further include a user input interface 2020 (e.g., touch screen, keyboard, keypad, mouse, etc.) and/or a display device 2022.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, JavaScript, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, LabVIEW, dynamic programming languages, such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions, when stored in the computer readable medium, produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

It will be understood that, although the terms “first,” “second,” etc. may be used herein to describe various elements, these elements should not be limited by these terms. These terms are only used to distinguish one element from another. Thus, a first element could be termed a second element without departing from the teachings of the inventive subject matter.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described to best explain the principles of the disclosure and the practical application, and to enable others of ordinary skill in the art to understand the disclosure with various modifications as are suited to the particular use contemplated.

1. A method comprising:
performing operations as follows by a processor:
determining a source address or a target address of an inbound packet received by a single application from a first tenant of a multitenant network comprising a plurality of tenants;
determining a network interface on which the inbound packet from the first tenant is received;
marking the inbound packet with a mark based on the network interface;
preparing an outbound packet in response to the inbound packet, the outbound packet comprising the source address or the target address;
marking the outbound packet with the mark; and
routing the outbound packet to the network interface for forwarding to the first tenant based on the mark.

2. The method of claim 1,
wherein the source address comprises a first network address of the first tenant that overlaps with a second network address of a second tenant of the plurality of tenants that are communicating with the single application.

3. The method of claim 2,
wherein the first network address comprises the second network address.

4. The method of claim 2, wherein the inbound packet comprises a first inbound packet, wherein the network interface comprises a first network interface, and wherein the mark comprises a first mark, the method further comprising:
determining a second network interface on which a second inbound packet from the second tenant is received; and
marking the second inbound packet with a second mark based on the second network interface,
wherein the first network interface is different from the second network interface, and
wherein the first mark is different from the second mark.

5. The method of claim 4, wherein the outbound packet comprises a first outbound packet, and wherein a first source address of the first inbound packet from the first tenant comprises the source address, and wherein a second source address of the second inbound packet from the second tenant comprises the source address, the method further comprising:
preparing a second outbound packet in response to the second inbound packet, the second outbound packet comprising the source address;
marking the second outbound packet with the second mark; and
routing the second outbound packet to the second network interface for forwarding to the second tenant based on the second mark.

6. The method of claim 5, further comprising:
determining a first routing policy for routing the first outbound packet to the first network interface for forwarding to the first tenant based on a first combination of the first source address and the first mark; and
determining a second routing policy for routing the second outbound packet to the second network interface for forwarding to the second tenant based on a second combination of the second source address and the second mark,
wherein the routing the first outbound packet to the first network interface is based on the first routing policy, and
wherein the routing the second outbound packet to the second network interface is based on the second routing policy.

7. The method of claim 1, further comprising:
determining a Virtual Local Area Network (VLAN) identifier associated with the inbound packet,
wherein the routing the outbound packet is further based on the VLAN identifier.

8. The method of claim 2, wherein the inbound packet comprises a first inbound packet, and wherein the mark comprises a first mark, the method further comprising:
determining that a second inbound packet from the second tenant is received on the network interface on which the first inbound packet is received; and
determining a first Virtual Local Area Network (VLAN) identifier associated with the first inbound packet and a second VLAN identifier associated with the second inbound packet;
wherein the marking the first inbound packet comprises marking the first inbound packet with the first mark based on the network interface and the first VLAN identifier.

9. The method of claim 8, further comprising:
marking the second inbound packet with a second mark based on the network interface and the second VLAN identifier,
wherein the first mark is different from the second mark.

10. The method of claim 9, wherein the outbound packet comprises a first outbound packet, and wherein a first source address of the first inbound packet from the first tenant comprises the source address, and wherein a second source address of the second inbound packet from the second tenant comprises the source address, the method further comprising:
preparing a second outbound packet in response to the second inbound packet, the second outbound packet comprising the source address;
marking the second outbound packet with the second mark;
associating the second outbound packet with the second VLAN identifier based on the second mark; and
routing the second outbound packet to the network interface for forwarding to the second tenant based on the second mark and the second VLAN identifier associated with second outbound packet.

11. The method of claim 10, further comprising:
determining a first routing policy for routing the first outbound packet to a first network interface for forwarding to the first tenant based on a first combination of the first source address, the first VLAN identifier, and the first mark; and
determining a second routing policy for routing the second outbound packet to a second network interface for forwarding to the second tenant based on a second combination of the second source address, the second VLAN identifier, and the second mark,
wherein the routing the first outbound packet to the first network interface is based on the first routing policy, and
wherein the routing the second outbound packet to the second network interface is based on the second routing policy.

12. The method of claim 1,
wherein the mark does not alter data in the inbound packet that was received.

13. The method of claim 1,
wherein the mark is maintained in an upstream and a downstream direction by a local network stack.

14. The method of claim 1,
wherein the network interface comprises at least one of a physical interface, a virtual interface, or a tunnel endpoint.

15. The method of claim 1,
wherein the operations are performed by the single application.

16. The method of claim 1,
wherein the operations are performed by a customer aggregation switch associated with a virtual network appliance without modifying the single application running on a service provider host.

17. A computer program product, comprising:
a tangible, non-transitory computer readable storage medium comprising computer readable program code embodied therein, the computer readable program code comprising:
computer readable code to determine a source address or a target address of an inbound packet received by a single application from a first tenant of a multitenant network comprising a plurality of tenants;
computer readable code to determine a network interface on which the inbound packet from the first tenant is received;
computer readable code to mark the inbound packet with a mark based on the network interface;
computer readable code to prepare an outbound packet in response to the inbound packet, the outbound packet comprising the source address or the target address;
computer readable code to mark the outbound packet with the mark; and
computer readable code to route the outbound packet to the network interface for forwarding to the first tenant based on the mark.

18. The computer program product of claim 17, wherein the inbound packet comprises a first inbound packet, wherein the network interface comprises a first network interface, and wherein the mark comprises a first mark, the computer readable program code further comprising:
computer readable code to determine a second network interface on which a second inbound packet from a second tenant is received; and
computer readable code to mark the second inbound packet with a second mark based on the second network interface,
wherein the first network interface is different from the second network interface, and
wherein the first mark is different from the second mark.

19. The computer program product of claim 17, wherein the inbound packet comprises a first inbound packet, and wherein the mark comprises a first mark, the computer readable program code further comprising:
computer readable code to determine that a second inbound packet from a second tenant is received on the network interface on which the first inbound packet is received;
computer readable code to determine a first Virtual Local Area Network (VLAN) identifier associated with the first inbound packet and a second VLAN identifier associated with the second inbound packet;
computer readable code to mark the first inbound packet with the first mark based on the network interface and the first VLAN identifier; and
computer readable code to mark the second inbound packet with a second mark based on the network interface and the second VLAN identifier,
wherein the first mark is different from the second mark.

20. A computer system, comprising:
a processor; and
a memory coupled to the processor, the memory comprising computer readable program code embodied therein that, when executed by the processor, causes the processor to perform operations comprising:
determining a source address or a target address of an inbound packet received by a single application from a first tenant of a multitenant network comprising a plurality of tenants;
determining a network interface on which the inbound packet from the first tenant is received;
marking the inbound packet with a mark based on the network interface;
preparing an outbound packet in response to the inbound packet, the outbound packet comprising the source address or the target address;
marking the outbound packet with the mark; and
routing the outbound packet to the network interface for forwarding to the first tenant based on the mark.
